(19) United States
(12) Patent Application Publication
(10) Pub. No.: US 2008/0282849 A1
(43) Pub. Date: Nov. 20, 2008

(54) WRENCH MADE AT LOWER COST AND IN LESS TIME

(75) Inventor: Arthur Wu, Taichung (TW)

Correspondence Address: Dr. BANGER SHIA, 102 Lindencrest Ct., Sugar Land, TX, 77479-5201, US

(73) Assignee: PROXENE TOOLS CO., LTD., Taichung (TW)

(21) Appl. No.: 12/146,628

(22) Filed: Jun. 26, 2008

Related U.S. Application Data
(63) Continuation-in-part of application No. 11/798,953, filed on May 16, 2007.

(51) Int. Cl. B25B 13/16

(52) U.S. Cl. 81/165

(57) ABSTRACT

A wrench comprises a main body including a handle and a head including a fixed jaw and a groove and a passage which is located parallel to and communicates with the groove, a through hole defined through the head and communicating with the groove and the passage. A mediate member made of metal and integrally connected with the head by using injection, and including a protrusion, a tubular portion and a frame with an opening, the protrusion connected to the fixed jaw, the tubular portion engaged with the groove and the frame engaged with the through hole. A movable jaw made of metal and including a sliding rod slidably received in the tubular portion, a plurality of teeth defined in an underside of the sliding rod. An adjusting member made of metal and engaged with the opening of the frame, the adjusting member engaged with the teeth of the sliding rod.

This application is a Continuation in Part (CIP) of previously U.S. application Ser. No. 11/798,953, and claims the priority of the filing date of May 16, 2007, and claims 1-8 in the current CIP application correspond to claims 13-20 in the parent application, respectively, and are entitled to the parent application's filing date of May 16, 2007.

### BACKGROUND OF THE INVENTION

(1) Field of the Invention

(2) Description of the Prior Art

A conventional wrench includes multiple parts and some parts include complicated shapes which require many steps of treatments to finish. The conventional wrench generally is made of metallic material such as alloy and the necessary processes for making the wrench are hot forging, annealing, sand spraying, machining, heat treatment, grinding and polishing. Therefore, the time required to finish a wrench is too long to keep its price competition in market.

The present invention has arisen to mitigate and/or obviate the afore-described disadvantages.

### SUMMARY OF THE INVENTION

The primary object of the present invention is to provide a wrench that may be produced at low cost and in less time.

In accordance with one aspect of the present invention, there is provided a wrench made at lower cost and in less time comprising

a main body including a handle and a head, the head including a fixed jaw and a groove and a passage which is located parallel to the groove and communicates with the groove, a through hole defined through the head and communicating with the groove and the passage, and

a mediate member made of metal and integrally connected with the head by way of injection, the mediate member including a protrusion, a tubular portion and a frame with an opening, the protrusion connected to the fixed jaw, the tubular portion engaged with the groove and the frame engaged with the through hole;

a movable jaw made of metal and including a sliding rod which is slidably received in the tubular portion, a plurality of teeth defined in an underside of the sliding rod, and

an adjusting member made of metal and engaged with the opening of the frame, the adjusting member further engaged with the teeth of the sliding rod.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view illustrating the exploded components of a wrench made at lower cost and in less time according to the present invention;

FIG. 2 is a perspective view illustrating the assembly of the wrench made at lower cost and in less time according to the present invention;

FIG. 3 is a plan view illustrating the assembly of the wrench made at lower cost and in less time according to the present invention;

FIG. 4 is a perspective view illustrating the exploded components of a wrench made at lower cost and in less time according to another embodiment of the present invention.

### DETAILED DESCRIPTION OF THE PREFERRED EMBODIMENTS

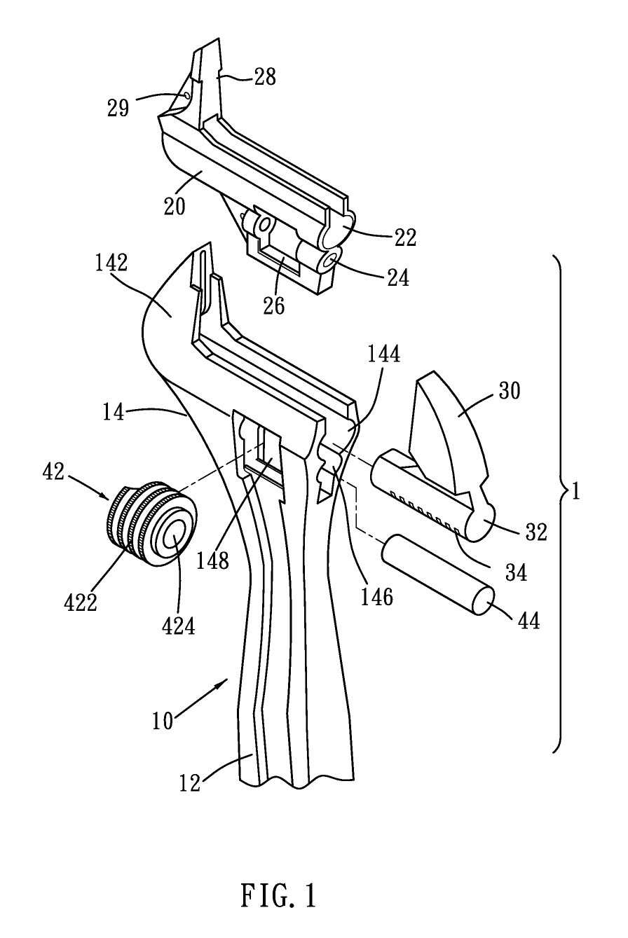

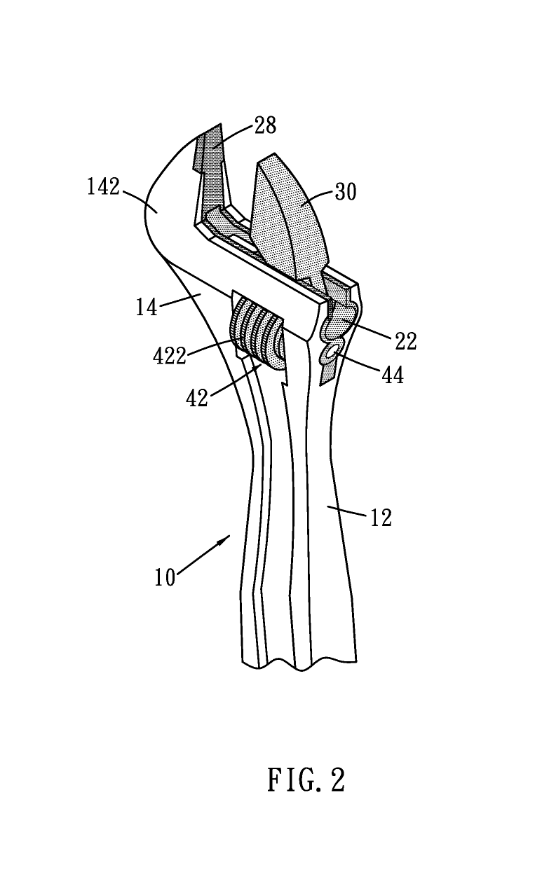

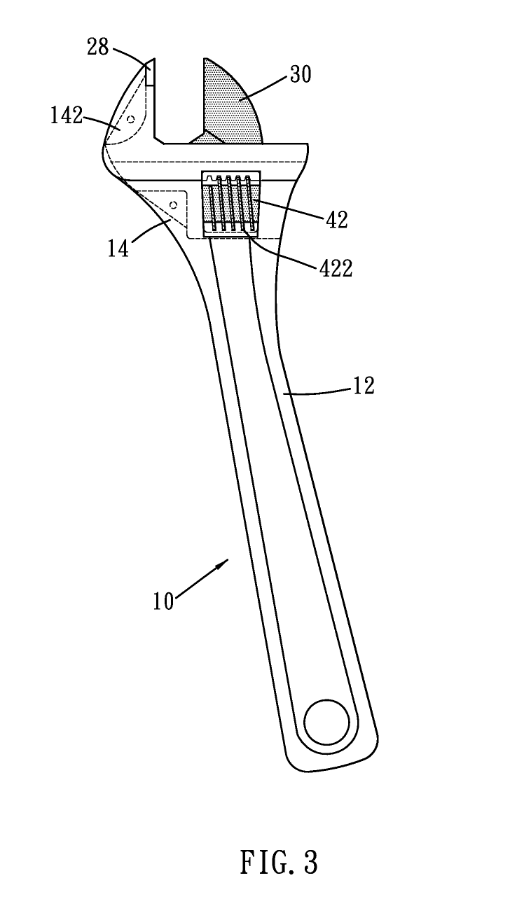

Referring to FIGS. 1 to 3, the wrench 1 made at lower cost and in less time of the present invention comprises a main body 10 which is made of nonmetallic material such as carbon fibers and glass fibers, or non-iron material such as aluminum alloy or zinc alloy. The main body 10 includes a handle 12 and a head 14 which includes a stepped fixed jaw 142 extending from an end of a top thereof and a groove 144 and a passage 146 are defined transversely in the head 14. The passage 146 is located parallel to the groove 144 and communicates with the groove 144. A through hole 148 is defined through the head 14 and communicates with the groove 144 and the passage 146.

A mediate member 20 is made of metal and integrally connected with the head 14 by way of injection. The mediate member 20 includes a protrusion 28, a tubular portion 22 and a frame 26 with an opening. Two through holes 24 are defined in tow sidewalls of the frame 26. The protrusion 28 is inserted in the hollow fixed jaw 142 from an open side and a part of the mediate member 20 is located outside of the open side. The tubular portion 22 includes an axial open top and is engaged with the groove 144. The frame 26 is engaged with the through hole 148.

A movable jaw 30 made of metal and includes a sliding rod 32 which is connected on the lower side thereof and slidably received in the tubular portion 22. A plurality of teeth 34 are defined in an underside of the sliding rod 32.

An adjusting member is made of metal and received in the opening of the frame 26. The adjusting member is a metal worm member 42 which includes a passage 424 defied axially therethrough and a shaft 44 extends through the two through holes 24 in the mediate member 20 and the passage 424, so that the worm member 42 is engaged with the teeth 34 of the sliding rod 32 by teeth 422 defined in an outer periphery thereof. The user allows to simply rotate the worm member 42 to drive the movable jaw 30 along the groove 144.

The mediate member 20 includes a hole 29 defined therethrough so that when the material of the main body 10 is ejected in molding process, the material is filled in the hole 29 to firmly connect the mediate member 20 with the fixed jaw 142. The main body 10 can also be connected to the mediate member 20 by rivets or any known method.

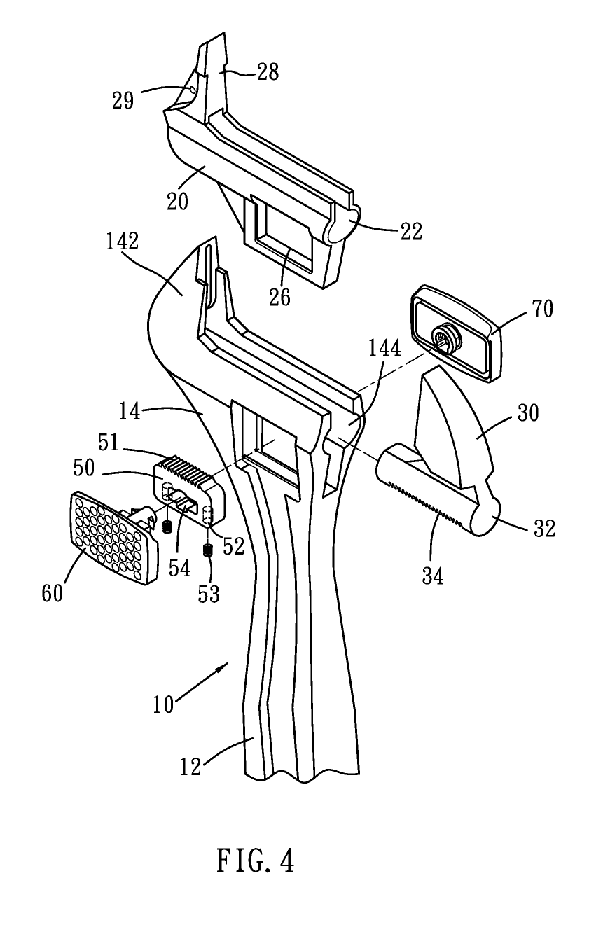

FIG. 4 shows another embodiment of a wrench made at lower cost and in less time, it is to be noted that the through holes 24 are disclosed in the frame 26 of the first embodiment, thus the same detailed description are omitted. The adjusting member includes a restriction member 50, a male part 60 and a female part 70. The restriction member 50 is sandwiched between the male part 60 and the female part 70. The restriction member 50 is engaged with the opening of the frame 26 and includes teeth 51 defined in a top thereof. Two recesses 52 are defined in an underside of the restriction member 50 and two springs 53 are inserted in the two recesses 52 so that the restriction member 50 is pushed upward and the teeth 51 are engaged with the teeth 34 on the sliding rod 32. A central hole 54 is defined through the restriction member 50 so that the male part 60 and the female part 70, each having a part, are inserted through the central hole 54 to connect with each other. When the user pulls the restriction member 50 downward to disengage the teeth 51 from the teeth 34 of the sliding rod 32, the fixed jaw 30 can be movable.

While we have shown and described the embodiment in accordance with the present invention, it should be clear to those skilled in the art that further embodiments may be made without departing from the scope of the present invention.

What is claimed is:

1. A wrench made at lower cost and in less time comprising:
a main body made of non-iron material and including a handle and a head which includes a fixed jaw extending from an end of a top thereof, and includes a groove and a passage defined transversely in the head and being located parallel to and communicating with the groove, and including a through hole defined through the head and communicating with the groove and the passage;
a mediate member made of metal and integrally connected with the head by way of injection, the mediate member including a protrusion, a tubular portion and a frame;
a movable jaw slidably received in the tubular portion, and including a plurality of teeth defined in an underside of a sliding rod thereof; and
an adjusting member made of metal and received in the opening of the frame of the mediate member and engaged with the teeth of the sliding rod of the movable jaw, so that the movable jaw is driven to freely displace in the tubular portion.

2. The wrench made at lower cost and in less time as claimed in claim 1, wherein the main body is tightly connected to the mediate member by rivets.

3. The wrench made at lower cost and in less time as claimed in claim 1, wherein the non-iron material made into the body is aluminum alloy.

4. The wrench made at lower cost and in less time as claimed in claim 1, wherein the non-iron material made into the body is zinc alloy.

5. The wrench made at lower cost and in less time as claimed in claim 1, wherein the mediate member includes a hole defined therethrough.

6. The wrench made at lower cost and in less time as claimed in claim 1, wherein the adjusting member includes a metal worm member which includes a passage defied axially therethrough and a shaft extends through the passage.

7. The wrench made at lower cost and in less time as claimed in claim 1, wherein the adjusting member includes a restriction member, a male part and a female part, the restriction member is sandwiched between the male part and the female part.

8. The wrench made at lower cost and in less time as claimed in claim 7, wherein the restriction member is engaged with the opening of the frame and includes teeth defined in a top thereof, two recesses are defined in an underside of the restriction member and two springs are inserted in the two recesses, a central hole is defined through the restriction member so that the male part and the female part each have a part inserted through the central hole to connected to each other.

9. A wrench made at lower cost and in less time comprising:
a main body made of the nonmetallic material and including a handle and a head which includes a fixed jaw extending from an end of a top thereof, and includes a groove and a passage defined transversely in the head and being located parallel to and communicating with the groove, and including a through hole defined through the head and communicating with the groove and the passage;
a mediate member made of metal and integrally connected with the head by way of injection, the mediate member including a protrusion, a tubular portion and a frame;
a movable jaw slidably received in the tubular portion, and including a plurality of teeth defined in an underside of a sliding rod thereof; and
an adjusting member made of metal and received in the opening of the frame of the mediate member and engaged with the teeth of the sliding rod of the movable jaw, so that the movable jaw is driven to freely displace in the tubular portion.

10. The wrench made at lower cost and in less time as claimed in claim 9, wherein the main body is tightly connected to the mediate member by rivets.

11. The wrench made at lower cost and in less time as claimed in claim 9, wherein the nonmetallic material made into the main body is carbon fibers.

12. The wrench made at lower cost and in less time as claimed in claim 9, wherein the nonmetallic material made into the main body is glass fibers.

13. The wrench made at lower cost and in less time as claimed in claim 9, wherein the mediate member includes a hole defined therethrough.

14. The wrench made at lower cost and in less time as claimed in claim 9, wherein the adjusting member includes a metal worm member which includes a passage defied axially therethrough and a shaft extends through the passage.

15. The wrench made at lower cost and in less time as claimed in claim 9, wherein the adjusting member includes a restriction member, a male part and a female part, the restriction member is sandwiched between the male part and the female part.

16. The wrench made at lower cost and in less time as claimed in claim 15, wherein the restriction member is engaged with the opening of the frame and includes teeth defined in a top thereof, two recesses are defined in an underside of the restriction member and two springs are inserted in the two recesses, a central hole is defined through the restriction member so that the male part and the female part each have a part inserted through the central hole to connected to each other.
